(19) United States
(12) Patent Application Publication
(10) Pub. No.: US 2018/0359356 A1
(43) Pub. Date: Dec. 13, 2018

(54) PROMPTING METHOD AND APPARATUS

(71) Applicant: Alibaba Group Holding Limited, Grand Cayman (KY)

(72) Inventors: Qing Ren, Hangzhou (CN); Hang Chen, Zhejiang (CN)

(73) Assignee: Alibaba Group Holding Limited

(21) Appl. No.: 16/104,660

(22) Filed: Aug. 17, 2018

Related U.S. Application Data
(63) Continuation of application No. PCT/CN2017/072880, filed on Feb. 4, 2017.

(30) Foreign Application Priority Data
Feb. 17, 2016 (CN) 201610090367.6

(51) Int. Cl. H04M 1/725

(52) U.S. Cl. CPC H04M 1/72597

(57) ABSTRACT

A prompting method and apparatus are disclosed. The method includes: detecting a communication event; and when a preset trigger event for switching the communication event from an execution state to a termination state is monitored, executing a preset prompting operation on a local communication party to prompt the local communication party to send a reminder related to the communication event to an opposite communication party. By adoption of the technical solutions of the present application, a user can be helped to execute a sending operation of the reminder.

The present application claims priority to and is a continuation of PCT Patent Application No. PCT/CN2017/072880, filed on Feb. 4, 2017, which claims priority to Chinese Application No. 201610090367.6, filed on Feb. 17, 2016 and entitled “PROMPTING METHOD AND APPARATUS,” which are incorporated herein by reference in their entirety.

### TECHNICAL FIELD

The present disclosure relates to the technical field of communications, and in particular, to prompting methods and apparatuses.

### BACKGROUND

By establishing a communication event, users can negotiate more conveniently. However, the communication event may be unsuccessful in facilitating negotiation between the users; or, for certain types of communication events, the negotiation results may be easily forgotten by the users due to the inability of forming visual information such as text and pictures. As such, if a corresponding reminder can be sent to opposite end user in view of the communication event, it would be helpful for the completion and handling of subsequent matters.

However, especially in scenarios involving an enterprise team, the users often forget to transmit the reminders due to having to attend to numerous matters.

### SUMMARY OF THE INVENTION

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of this, the present disclosure provides prompting methods and apparatuses, which can help a user to execute a sending operation of a reminder.

To achieve the above objective, the present disclosure provides technical solutions as follows:

According to an aspect of the present disclosure, a prompting method is provided, including:

detecting a communication event; and

when a preset trigger event for switching the communication event from an execution state to a termination state is detected, executing a preset prompting operation on a local communication party to prompt the local communication party to send a reminder related to the communication event to an opposite communication party.

According to another aspect of the present disclosure, a prompting apparatus is provided, including:

a detection unit configured to detect a communication event; and

a prompting unit configured to, when a preset trigger event for switching the communication event from an execution state to a termination state is detected, execute a preset prompting operation on a local communication party to prompt the local communication party to send a reminder related to the communication event to an opposite communication party.

As can be seen from the above technical solutions, the present application can help the user to execute the sending operation of the reminder by executing the prompting operation when the communication event is terminated, so as to facilitate, for example, the reminding and summarizing of the communication event by both communication parties, thereby enhancing the handling efficiency of related events.

### BRIEF DESCRIPTION OF THE DRAWINGS

FIG. 1 is a flowchart of a prompting method of an exemplary embodiment of the present disclosure;

FIG. 2 is a flowchart of a prompting method by a calling party of an exemplary embodiment of the present disclosure;

FIG. 3 is a schematic diagram of a prompting interface of a calling party of an exemplary embodiment of the present disclosure;

FIG. 4 is a schematic diagram of another prompting interface of a calling party of an exemplary embodiment of the present disclosure;

FIG. 5 is a flowchart of a prompting method by a called party of an exemplary embodiment of the present disclosure;

FIG. 6 is a structural schematic diagram of an electronic device of an exemplary embodiment of the present disclosure;

FIG. 7 is a block diagram of a prompting apparatus of an exemplary embodiment of the present disclosure.

### DETAILED DESCRIPTION OF THE EMBODIMENTS

The present disclosure provides a prompting solution that can help a user to execute a sending operation of a reminder. To further illustrate the present disclosure, the following embodiments are provided:

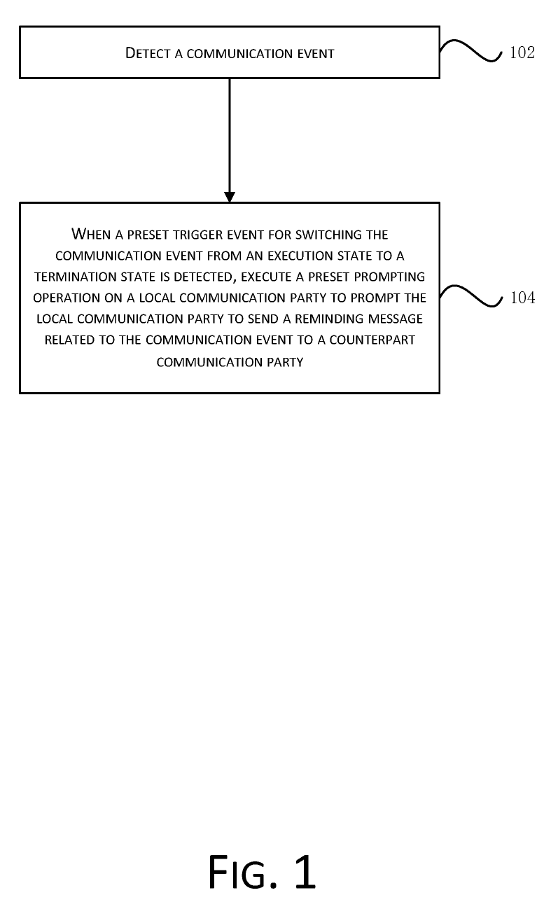

FIG. 1 is a flowchart of a prompting method of an exemplary embodiment of the present disclosure. As shown in FIG. 1, the method is applied to an electronic device and can include the following steps:

Step 102, a communication event is detected.

In the present embodiment, the communication event may be of various types such as, not but limited to, voice call, video call, short message, email, instant message and the like. For convenience, the present disclosure is described using a call process as an example.

Step 104, when a preset trigger event for switching the communication event from an execution state to a termination state is detected, a preset prompting operation is executed on a local communication party to prompt the local communication party to send a reminder related to the communication event to opposite counterpart communication party.

In a case of the present embodiment, the call process (or other type of communication event) can be initiated or responded to through a first application, and the reminder is sent by a second application. For example, the first application may be a “telephone” application on an electronic device (in the form of a Circuit Switch (CS)-based conventional telephone form, a Packet Switch (PS)-based Voice over Internet Protocol (VOIP) telephone form, or a telephone form that triggers, through the data information of the PS domain, a CS domain-based call process. The second application may be an instant messaging application, the instant messaging application may be an enterprise instant messaging (EIM) application, such as the enterprise instant messaging application “Ding Talk”, and the reminder sent by the same may include any type of instant messages, short messages, emails, and so on.

In another case of the present embodiment, the call process can be initiated or responded to and the reminder may be sent by the same application, and the application may be the above-mentioned instant messaging application, such as the enterprise instant messaging application “Ding Talk”.

In the present embodiment, the preset trigger event for implementing state switching is related to a scenario. Therefore, based on the change of the scenario, there are many different types of preset trigger events. The preset trigger events and prompting operations in the corresponding scenarios for the call process are described below by examples.

First scenario: the local communication party is not responded to by the opposite communication party.

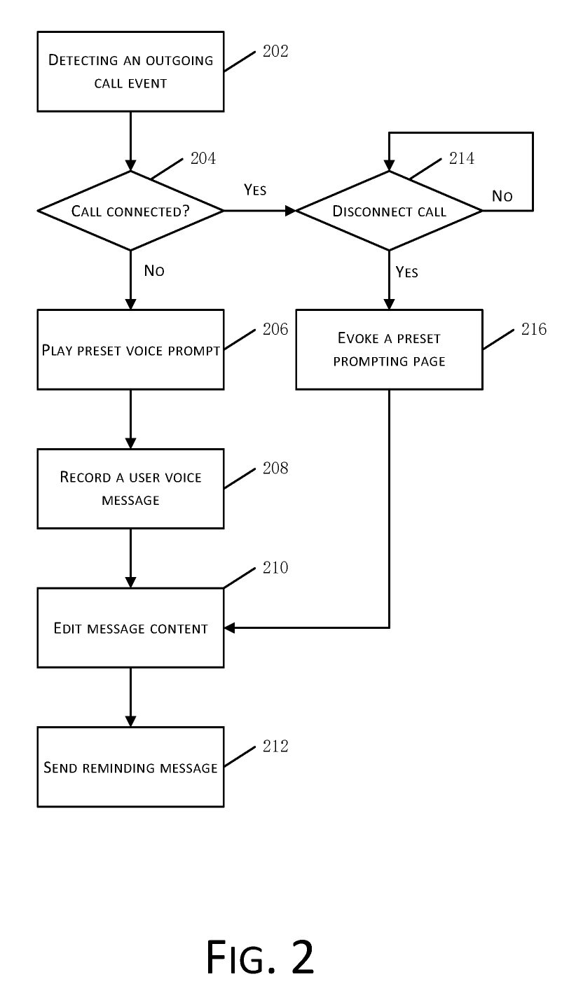

As an exemplary embodiment, FIG. 2 is a flowchart of a prompting method by a calling party of an exemplary embodiment of the present disclosure. As shown in FIG. 2, steps 202-212 of the prompting method provide an application scenario from the perspective of a local communication party, the preset trigger event in the application scenario may include: a communication event initiated by the local communication party is not responded to by the opposite communication party; then, the corresponding processing process may include:

Step 202, detect an outgoing call event.

In the present embodiment, the “outgoing call event” refers to the local communication party initiating the communication event to the opposite communication party, for example, calling a telephone number of the opposite communication party.

Step 204: when the call is connected, execute step 214, which will be described in detail below and will not be described here redundantly; and when the call is not connected, execute step 206.

Step 206: play a preset prompting voice message.

In the present embodiment, as an exemplary embodiment, the prompting operation may be executed by playing the preset prompting voice message to prompt the local communication party to send a reminder to the opposite communication party; then, with the call process as an example, assuming that the local communication party is user A, and the opposite communication party is user B, then steps 202-206 may be understood as the following process:

1) Call process. User A calls user B using an electronic device such as a mobile phone, and before user B answers the call, user A may hear an on-hold prompt tone played through the electronic device.

2) Prompting process. User B does not answer the call of the user A due to various reasons (i.e., the preset triggering event: “not responded to by the opposite communication party”), resulting in the failure and termination of the call (i.e., switching to the termination state), then the electronic device used by user A stops playing the above-mentioned on-hold prompt tone and plays the preset prompting voice message instead.

Based on the consistency of user A's operation, for example, user A keeps listening to the on-hold prompt tone while waiting for a response from user B and, when the on-hold prompt tone suddenly stops playing, user A still keeps listening, playing the preset prompting voice message at that moment can ensure that user A can successfully hear the voice message, thus achieving a prompting effect.

The preset prompting voice message may include contents related to sending the prompt message, for example, “the other party may not be at the phone, you may send a DING message to him/her first” and the like; and of course, the contents of the preset prompting voice message may be edited and modified according to actual situations.

Step 208, record a user voice.

In the present embodiment, the electronic device may execute a reminding operation using the opposite communication party as the target, according to a received confirmation instruction, so as to send the reminder to the opposite communication party. The “user voice” recorded herein is used as the voice message content of the reminder. Of course, “voice” is only one of the specific forms that may be adopted. In fact, the reminder corresponding to the local communication party may also be generated by inputting text, selecting function items, or by other means. The above description is for illustration only and does not limit the ways a reminder can be generated in the present disclosure.

In one case, after the electronic device determines that the call process is switched to the termination state, the electronic device may issue the above-mentioned confirmation instruction to directly enter the process of generating the reminder. For example, in step 208, the user voice may be directly collected and recorded to serve as the content of the reminder.

The preset prompting voice may include, for example, “please produce a voice reminder content within 10 seconds after the “beep,” so that the local communication party may control the start time and end time of the recorded voice content.

In another case, the electronic device may determine that the above-mentioned confirmation instruction is received when detecting a preset response operation for the prompting operation, thereby giving the user the right of autonomous control. The preset response operation may include any predefined operation. For example, the local communication party may send “OK, Ding Ding” or other preset voice messages, and touch a preset function key on a screen (for example, input a preset number combination on a dial plate) to accomplish the preset response operation. Of course, the present disclosure is not limited in how this can be achieved.

Step 210, edit the message content.

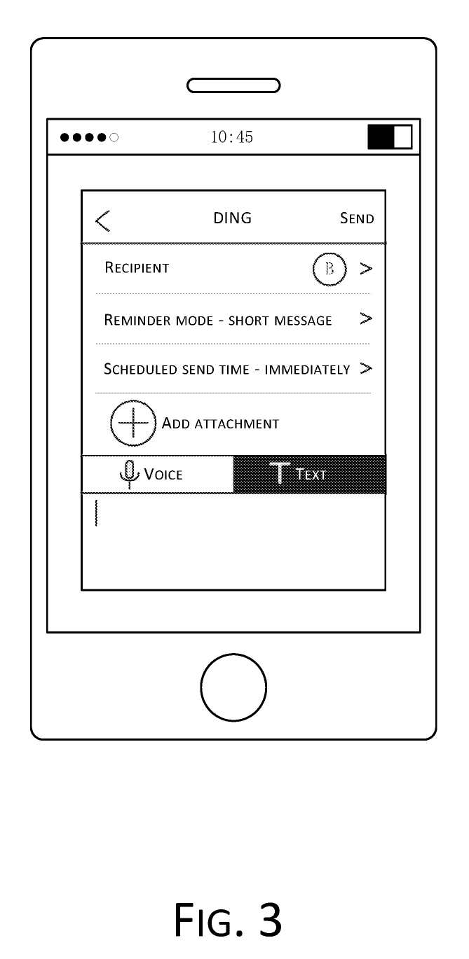

In the present embodiment, the local communicator may edit the rest of the content of the reminder in addition to forming the content of the reminder in the above-mentioned manners such as using voice. For example, as shown in FIG. 3, using the reminder of a “DING message” type supported by “DING Talk” as an example, after the electronic device records the user voice, the message editing page as shown in FIG. 3 may be displayed, then the local communication party may edit the “recipient” (the opposite communication party set as the default, for example, user B as shown in FIG. 3), the “reminding mode”, the “sending time” and the like on the page, and may also perform “add attachment”, inputting text, and other operations so as to add more contents. When selecting “voice”, the local communication party can listen to the user voice recorded in step 208, and can continue to record additional voice information.

Step 212, send the reminder.

In the present embodiment, the electronic device may send the reminder such as a DING message in a form determined by the “reminding mode” as shown in FIG. 3. The sending mode of the reminder may take many forms including, for example, calling the opposite end communication party and playing the voice contents after the call is connected; or, sending a short message, an email, an instant message, or other messages including a voice message, text and other contents to the opposite communication party.

Certainly, in the application scenario of the present embodiment, the electronic device triggers the prompting operation when the communication event is not responded to by the opposite communication party. Therefore, in order to ensure that the reminding operation can successfully send the reminder to the opposite communication party, the execution mode of the reminding operation may be different from that of the previously-used communication event. For example, when the communication event is a call event, the reminding operation may be in the form of a short message.

Second scenario: the communication event is responded to by the opposite communication party but is terminated.

As another exemplary embodiment, FIG. 2 is a flowchart of a prompting method by a calling party, according to an exemplary embodiment of the present application. As shown in FIG. 2, steps 202-204 and 214-216 of the prompting method provide an application scenario from the perspective of the local communication party. The preset trigger event in the application scenario may include: after being responded to by the opposite communication party, the communication event is terminated by the local communication party or the opposite communication party; and then, the corresponding processing process may include:

Step 202, detect an outgoing call event.

Step 204: when the call is connected, execute step 214; and when the call is not connected, execute step 206, which is not described herein redundantly.

Step 214: when the call is disconnected, execute step 216.

In the present embodiment, the call may be disconnected by the local communication party and may also be disconnected by the opposite communication party, and this is not limited in the present disclosure. After the local communication party forms the communication event with the opposite communication party by making a call or the like, mutual negotiation and communication have been achieved between the local communication party and the opposite communication party, but no complete and effective visual record information, such as text, pictures or the like, is formed in the communication process. So, the prompting operation can be executed on the local communication party, so that the local communication party summarizes contents related to the communication event and sends the same to the opposite communication party through the reminder for facilitating handling of the subsequent matters.

Step 216, evoke a preset prompting page.

In the present embodiment, as an exemplary embodiment, the electronic device may evoke and display a preset prompting page related to the sending of the reminder to prompt the local communication party to perform editing on the page so as to form the reminder to the opposite communication party. Of course, the local communication party may also exit the page as shown in FIG. 3 by triggering the icon “<” at the upper left corner of the page as shown in FIG. 3, and does not generate the reminder.

For example, the above-mentioned preset prompting page may adopt the form shown in FIG. 3, and the local correspondent may edit the “recipient,” the “reminding mode,” the “sending time,” and the like, and may also execute an operation of “adding attachment” as well as input any text or voice.

Certainly, in the present embodiment, the technical means of “playing the preset prompting voice” in the first scenario may still be used to perform the prompting operation; and, in other words, any type of prompting operation may be used in each scenario. The above example is only for illustration and not to limit the present disclosure.

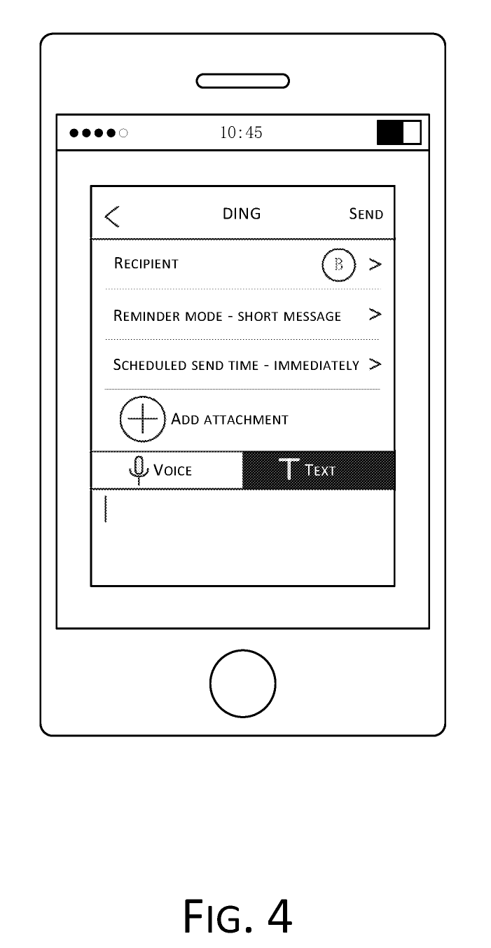

In addition, although the page shown in FIG. 3 is in the form of full-screen display, its presentation is not so limited in the present disclosure. For example, in order to enhance the association between the preset prompting page (or the “message editing page” in the first scenario) and the communication event, the page can be displayed in the form of a prompt floating widow as shown in FIG. 4. Then, the local communication party can exit the prompt floating window just by clicking the icon “<” at the upper left corner of the prompt floating window or the surrounding areas of the prompt floating window, so as to cancel the generation and sending of the reminder.

Third scenario: the communication event is responded to by the local communication party and is terminated.

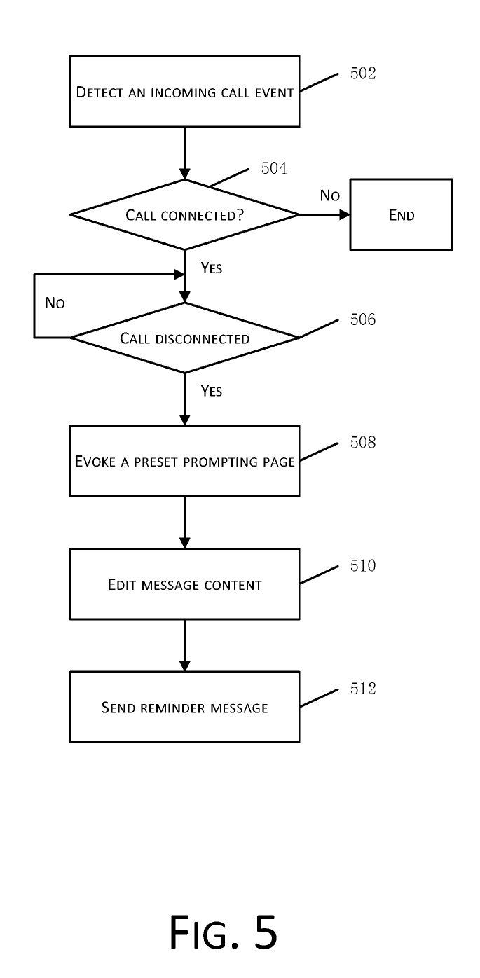

As another exemplary embodiment, FIG. 5 is a flowchart of a prompting method by a called party of an exemplary embodiment of the present disclosure. As shown in FIG. 5, the prompting method provides an application scenario from the perspective of the opposite communication party. The preset trigger event in the application scenario may include: after being responded to by the local communication party, the communication event is terminated by the local communication party or the opposite communication party; and then, the corresponding processing process may include:

Step 502, detect an incoming call event.

Step 504: when the call is connected, execute step 506; otherwise, terminate the process.

Step 506: when the call is disconnected, execute step 508; otherwise, keep the call on hold.

Step 508, evoke a preset prompting page.

Step 510, edit message contents.

Step 512, send a reminder.

In the present embodiment, the difference from the embodiment described in the second scenario lies in that: in the second scenario, the local communication party serves as an initiator (such as a calling party) of the communication event, and the opposite communication party serves as a responder (for example, a called party) of the communication event; and in the third scenario, the local communication party serves as the responder of the communication event, and responds to the communication event initiated by the opposite communication party.

In other words, the second scenario and the third scenario can be regarded as embodiments directed to the same communication event. The second scenario is described from the perspective of the initiator of the communication event, and the third scenario is described from the perspective of the responder of the communication event. In fact, when the communication event is responded to, for example, an actual call happens between the local communication party and the opposite communication party, the electronic device may perform the prompting operation, whether at the local communication party or the opposite communication party, to prompt the corresponding user to summarize the related information of the communication event and send the same to the opposite end user as a reminder.

Therefore, in the embodiment as shown in FIG. 5, the execution process of the prompting operation and the reminding operation is similar to that in the embodiment in the above-mentioned second scenario, and thus will not be repeated herein.

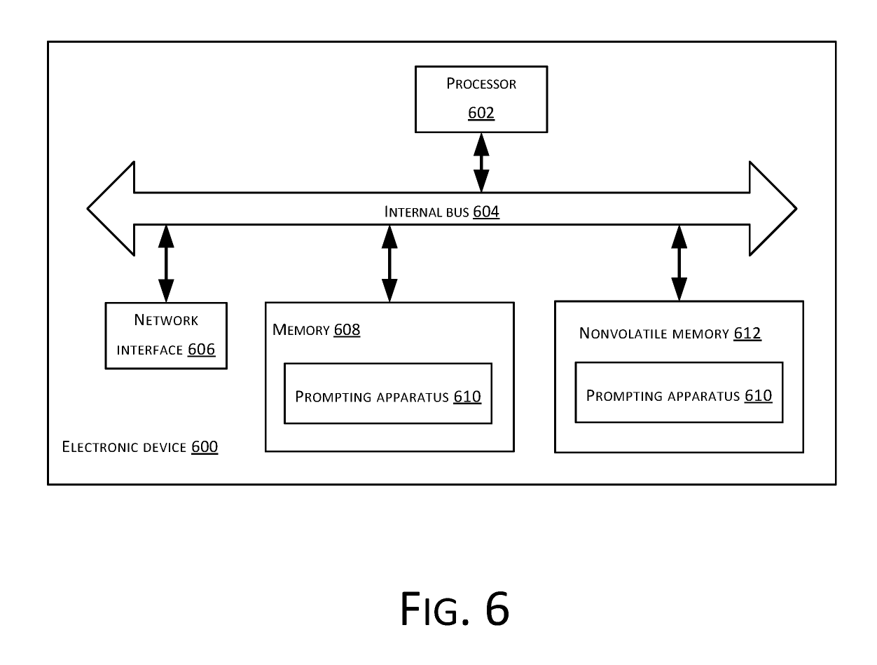

FIG. 6 shows a structural schematic diagram of an electronic device 600 of an exemplary embodiment of the present disclosure. Referring to FIG. 6, on the hardware level, the electronic device 600 includes a processor 602, an internal bus 604, a network interface 606, a memory 608, and a non-volatile memory 612, and of course, it may also include hardware required by other services. The processor 600 reads a corresponding computer program from the non-volatile memory 612 into the memory 608 and runs the same, and a prompting apparatus 610 is formed on a logic level. Of course, the present disclosure does not exclude implementation means other than using software, such as using a logic device or a combination of hardware and software, and so on. That is, the executing body of the following processing flow is not limited to logic units, and may also be hardware or logic devices.

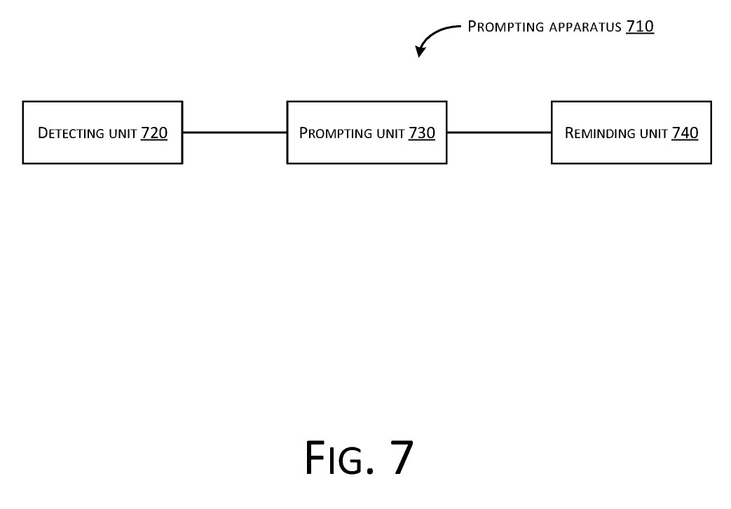

Referring to FIG. 7, in the software implementation, the prompting apparatus 710 may include a detection unit 720 and a prompting unit 740.

The detection unit 720 is used for detecting a communication event; and

the prompting unit 740 is used for, when a preset trigger event for switching the communication event from an execution state to a termination state is detected, executing a preset prompting operation on a local communication party to prompt the local communication party to send a reminder related to the communication event to an opposite communication party.

Optionally, the preset trigger event includes:

the communication event initiated by the local communication party is not responded to by the opposite communication party;

or, the communication event is terminated by the local communication party or the opposite communication party after being responded to.

Optionally, the prompting unit 730 executes the preset prompting operation on the local communication party through at least one of:

evoking and displaying a preset prompting page related to the sending of the reminder; and

playing a preset prompting voice message related to the sending of the reminder.

Optionally, the prompting apparatus further includes:

a reminding unit 740 configured to execute a reminding operation using the opposite communication party as a target object according to a received confirmation instruction so as to send the reminder to the opposite communication party.

Optionally, it is determined that the confirmation instruction is received when a preset response operation for the prompting operation is detected.

Optionally, the execution mode of the reminding operation is different from that of the communication event.

Optionally, the communication event includes a call event initiated through an instant messaging application.

Optionally, the instant messaging application includes an enterprise instant messaging application.

In a typical configuration, the computing device includes one or more processors (CPUs), an input/output interface, a network interface and a memory.

The memory may include a volatile memory in a non-transitory computer readable medium, a random access memory (RAM), and/or a non-volatile memory or other forms, such as a read only memory (ROM) or a flash memory (flash RAM). The memory is an example of the non-transitory computer readable medium.

The non-transitory computer readable medium includes permanent and non-permanent, removable and non-removable media. Information storage may be implemented by any method or technology. The information may be computer readable instructions, data structures, modules of programs or other data. Examples of the computer storage medium include, but are not limited to, a phase change memory (PRAM), a static random access memory (SRAM), a dynamic random access memory (DRAM), other types of random access memories (RAM), a read-only memory (ROM), an electrically erasable programmable read only memory (EEPROM), a flash memory or other memory techniques, a read-only compact disc read-only memory (CD-ROM), a digital multifunction disc (DVD), or other optical memories, cassette magnetic tapes, tape magnetic disk memories or other magnetic storage devices or any other non-transmission media, which may be used for storing information that may be accessed by the computing device. As defined herein, the computer readable medium does not include transitory media (transitory media), such as modulated data signals and carriers.

It should also be noted that the terms “include”, “comprise” or any other variations thereof are intended to cover non-exclusive inclusions, so that a process, a method, an article or a device that includes a series of elements not only includes those elements, but also includes other elements that are not explicitly listed, or also includes elements that are inherent to such process, method, article or device. In the case of no more limitation, the element defined by the phrase “includes a . . . ” does not exclude the existence of other identical element in the process, the method, the article, or the device including the element.

Described above are merely preferred embodiments of the present application, which are not intended to limit the present application. Any modifications, equivalent replacements, improvements and the like made within the spirit and principle of the present application shall be included within the protection scope of the present application.

What is claimed is:

1. A prompting method, comprising:
detecting a communication event; and
when a preset trigger event for switching the communication event from an execution state to a termination state is detected, executing a preset prompting operation on a local communication party to prompt the local communication party to send a reminder related to the communication event to an opposite communication party.

2. The method according to claim 1, wherein the preset trigger event comprises:
the communication event initiated by the local communication party is not responded to by the opposite communication party;
or, the communication event is terminated by the local communication party or the opposite communication party after being responded to.

3. The method according to claim 1, wherein executing the preset prompting operation on the local communication party comprises at least one of:
evoking and displaying a preset prompting page related to the sending of the reminder; and
playing a preset prompting voice message related to the sending of the reminder.

4. The method according to claim 1, further comprising:
executing a reminding operation using the opposite communication party as a target according to a received confirmation instruction so as to send the reminder to the opposite communication party.

5. The method according to claim 4, wherein it is determined that the confirmation instruction is received when a preset response operation for the prompting operation is detected.

6. The method according to claim 4, wherein an execution mode of the reminding operation is different from that of the communication event.

7. The method according to claim 1, wherein the communication event comprises a call event initiated through an instant messaging application.

8. The method according to claim 7, wherein the instant messaging application comprises an enterprise instant messaging application.

9. A prompting apparatus, comprising:
a detection unit configured to detect a communication event; and
a prompting unit configured to, when a preset trigger event for switching the communication event from an execution state to a termination state is monitored, execute a preset prompting operation on a local communication party to prompt the local communication party to send a reminder related to the communication event to an opposite communication party.

10. The apparatus according to claim 9, wherein the preset trigger event comprises:
the communication event initiated by the local communication party is not responded to by the opposite communication party;
or, the communication event is terminated by the local communication party or the opposite communication party after being responded to.

11. The apparatus according to claim 9, wherein the prompting unit executes the preset prompting operation on the local communication party through at least one of:
evoking and displaying a preset prompting page related to the sending of the reminder; and
playing a preset prompting voice message related to the sending of the reminder.

12. The apparatus according to claim 9, further comprising:
a reminding unit configured to execute a reminding operation using the opposite communication party as a target object according to a received confirmation instruction so as to send the reminder to the opposite communication party.

13. The apparatus according to claim 9, wherein the communication event comprises a call event initiated through an instant messaging application.

14. A non-transitory computer-readable storage medium storing computer-readable instructions executable by one or more processors, that when executed by the one or more processors, cause the one or more processors to perform operations comprising:
detecting a communication event; and
when a preset trigger event for switching the communication event from an execution state to a termination state is detected, executing a preset prompting operation on a local communication party to prompt the local communication party to send a reminder related to the communication event to an opposite communication party.

15. The non-transitory computer-readable storage medium of claim 14, wherein the preset trigger event comprises:
the communication event initiated by the local communication party is not responded to by the opposite communication party;
or, the communication event is terminated by the local communication party or the opposite communication party after being responded to.

16. The non-transitory computer-readable storage medium of claim 14, wherein executing the preset prompting operation on the local communication party comprises at least one of:
evoking and displaying a preset prompting page related to the sending of the reminder; and
playing a preset prompting voice message related to the sending of the reminder.

17. The non-transitory computer-readable storage medium of claim 14, wherein the operations further comprise:
executing a reminding operation using the opposite communication party as a target according to a received confirmation instruction so as to send the reminder to the opposite communication party.

18. The non-transitory computer-readable storage medium of claim 17, wherein it is determined that the confirmation instruction is received when a preset response operation for the prompting operation is detected.

19. The non-transitory computer-readable storage medium of claim 17, wherein an execution mode of the reminding operation is different from that of the communication event.

20. The non-transitory computer-readable storage medium of claim 14, wherein the communication event comprises a call event initiated through an instant messaging application.
